(19) United States
(12) Patent Application Publication
(10) Pub. No.: US 2026/0220133 A1
(43) Pub. Date: Jul. 30, 2026

(54) OFFLINE CONTENT ENRICHMENT FOR ENHANCED GENERATIVE RETRIEVAL

(71) Applicant: Intuit Inc., Mountain View, CA (US)

(72) Inventors: Dusan BOSNJAKOVIC, Los Angeles, CA (US); Anshuman SAHU, Los Gatos, CA (US); Shivakumara NARAYANASWAMY, Mountain View, CA (US); Shreya Venkatesh PRABHU, San Jose, CA (US)

(21) Appl. No.: 19/038,562

(22) Filed: Jan. 27, 2025

(51) Int. Cl. G06F 16/2453; G06F 40/40

(52) U.S. Cl. CPC G06F 16/24534; G06F 40/40

(57) ABSTRACT

Certain aspects provide a computer-implemented method for enhancing generative retrieval of content in response to user queries. The method includes generating a first prompt configured to cause a first language model (LM) to generate a set of synthetic queries related to a content dataset selected from a content database and transmitting, to the first LM, the content dataset and the first prompt as a first input. A first output comprising the set of synthetic queries is received from the first LM. A second prompt configured to cause a second LM to determine a subset of synthetic queries is generated and transmitted, to the second LM, with the set of synthetic queries as a second input. A second output comprising the subset of synthetic queries is received from the second LM. The content databased is then updated storing the subset of synthetic queries in the content database.

### BACKGROUND

### Field

Aspects of the present disclosure relate to techniques for performing enhanced generative content retrieval.

### Description of Related Art

Generative artificial intelligence (GenAI) refers to machine learning models that are able to create new content based on patterns and information learned from training data in combination with a user prompt. The user prompt provides instruction to the model on what new content to generate and how to generate that new content. Notably, the model is able to generate new content based on both the actual information (e.g., facts, knowledge) included in the training data, as well as patterns, insights, and model parameter weights learned from the training data.

GenAI models are able to generate new content in many different forms, including text, image, audio, and even video. For example, to facilitate text generation, some GenAI models are configured as language models (LMs). An LM is generally a type of machine learning model that is designed to understand, generate, and manipulate human language. More specifically, an LM is a probabilistic framework that determines the likelihood of a sequence of words or tokens. At its core, a LM attempts to predict the probability of the next word in a sentence given the preceding words. The model estimates these probabilities based on the patterns it learned during training. LMs are useful in natural language processing (NLP) and computational linguistics for performing a range of tasks involving human language.

LMs have a wide array of applications, including: text generation (e.g., producing coherent and contextually appropriate text; machine translation (e.g., converting text from one language to another); speech recognition (e.g., converting spoken language into text); text summarization (e.g., condensing a long piece of text into a shorter summary); sentiment analysis (e.g., determining the sentiment expressed in a piece of text); and question answering (e.g., automatically providing answers to questions posed in natural language).

LMs are often trained using large corpora of text. The training process involves adjusting the model's parameters to minimize the difference between its predicted word probabilities and the actual word sequences in the training data. This is typically done via techniques like maximum likelihood estimation and gradient descent. The training data set used at this stage of training is typically configured as a general-purpose training dataset, meaning the LM is trained to perform a wide range of tasks, including language understanding across many different knowledge domains. For example, LMs are trained on vast datasets that often include diverse and extensive sources of text from the internet, books, articles, and various other textual corpora (e.g., domain-specific corpora). The large volume of training data contributes to their broad generalization capabilities.

While language models represent a transformative force in many industries by assimilating vast amounts of knowledge, such as to build conversation-driven applications, these models are not without limitation. For example, while a powerful tool, a general-purpose LM may not be able to generate content and perform tasks related to specialized domains that were not represented in the original training data.

### SUMMARY

Certain aspects provide a computer-implemented method for enhancing generative retrieval of content in response to user queries. The method includes identifying a content dataset that is indexed in a content database that stores electronic content comprising information and context related to different user queries; generating a first prompt configured to cause a first language model (LM) to generate a set of synthetic queries related to the content dataset; transmitting, to the first LM, the content dataset and the first prompt as a first input; receiving, from the first LM, a first output comprising the set of synthetic queries related to the content dataset generated by the first LM based on the first input; generating a second prompt configured to cause a second LM to determine a subset of the set of synthetic queries, the subset including one or more synthetic queries selected from the set of synthetic queries based on the one or more synthetic queries at least meeting a relevancy score threshold; transmitting, to the second LM, the set of synthetic queries and the second prompt as a second input; receiving, from the second LM, a second output comprising the subset of synthetic queries generated by the second LM based on the second input; and updating the content database by storing the subset of synthetic queries with the related content dataset.

Certain aspects provide a computer-implemented method for enhancing generative retrieval of content in response to user queries. The method includes receiving a user query from a user interface; in response to receiving a user query, accessing a content database storing a plurality of content datasets indexed with corresponding synthetic queries that meet a minimum threshold relevancy value with respect to a corresponding content dataset of the plurality of content datasets; querying the content database with the user query; in response to querying the content database with the user query, retrieving one or more content datasets related to the user query based on the one or more content datasets being related to the user query and based on one or more synthetic queries corresponding to the one or more content datasets being related to the user query; transmitting, to a language model (LM), the one or more content datasets; receiving, from the LM, an enhanced response to the user query, the enhanced response comprising content selected from the one or more content datasets; and causing the enhanced response to be displayed at the user interface.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts a conventional user interface configured as a question-answer plugin that can be integrated into a software platform or website.

FIG. 2 depicts user interface 200 configured as a question-answer plugin that is configured to provide enhanced responses generated by an enhanced RAG-enabled LM.

FIG. 3 depicts a flowchart for an enhanced RAG-enabled LM system.

FIG. 4 depicts a flowchart of a process for updating a content database with relevant synthetic queries.

FIG. 5 depicts an example process of FIG. 4 with examples of synthetic queries and content datasets.

FIG. 6 depicts an example process for evaluating and filtering synthetic queries by a relevancy evaluator.

FIG. 7 depicts a flowchart of a process for generating relevancy scores for synthetic queries.

FIG. 8 depicts a flowchart of a process for generating enhanced responses to user queries.

FIG. 9 depicts a flowchart of a process for implementing a feedback loop to improve one or more underlying models of the offline dual-model system and the run-time system described herein.

FIG. 10 depicts a flowchart associated with an example method for enhancing generative retrieval of content in response to user queries.

FIG. 11 depicts a flowchart of another example method for enhancing generative retrieval of content in response to user queries.

FIG. 12 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

LM training typically starts with an untrained model (e.g., a model that has randomly initialized weights), and trains it to predict a next token given a sequence of previous tokens. In the context of LMs, tokens may be units of text that the models process and generate. Tokens can represent individual characters, words, subwords, or even larger linguistic units, depending on the specific tokenization (e.g., segmentation of text into meaningful units to capture its semantic and syntactic structure) approach used. Tokens act as a bridge between the raw text data and the numerical representations that LMs are able process. Training data used to train an LM generally includes publicly available “raw text,” for example, from books, articles, websites, and/or the like. To be highly capable (e.g., have linguistic and world knowledge), this text may span a wide range of fields, genres, languages, etc. Eventually, training on large amounts of text, the model learns to encode the structure of language in general (e.g., it learns, that “I like,” for example may be followed by a noun or a participle) as well as the knowledge included in the raw texts that the model was exposed to during training. Because the training data spans a wide variety of domains, these trained models are often referred to as general-purpose LMs.

Although a trained LM is, due to the knowledge it encodes, able to perform a variety of tasks, the model may lack specific knowledge that is not encoded in its training data. This knowledge may include (1) dynamic knowledge, (2) domain-specific knowledge, and/or (3) previously-acquired knowledge that has since been lost, to name a few. For example, dynamic knowledge refers to information that is constantly evolving, such as a user's age, an outstanding loan balance, stock prices, sensor data (e.g., such as from a thermostat inside a home), website analytics, and the like. Dynamic knowledge may become static and fail to evolve over time; thus, such knowledge encoded by the LM may become outdated.

Domain-specific knowledge (also referred to as “domain knowledge”) in machine learning (ML) refers to expertise and understanding of a specific field or subject matter (referred to herein as a “domain”) to which an ML model is applied. Accordingly, LMs may suffer from a domain knowledge deficit where they lack detailed, specialized knowledge for a particular domain, such as finance, healthcare, law, etc. in the base training dataset. For example, a general-purpose LM (e.g., off-the-shelf LM) trained on publicly-available data may not be able to respond, or may respond incorrectly, to a domain-specific prompt, such as a prompt requesting information about a company's financial statements and/or accounts, a prompt requesting software code for an application, a prompt requesting information about employee retention at a particular company for a previous year, a prompt requesting customer help with an application and/or system internal to a company, and/or the like. The trained LM may not be able to respond, or may respond incorrectly, given the information that is requested is not part of a publicly available training data used to train the LM.

To address the shortcomings of LMs, some conventional approaches seek to combine and orchestrate LM functionality with other sources of knowledge. For example, some conventional approaches use techniques to “fine-tune” LMs for specific domains, while also regularly performing updates to their knowledge bases. Fine-tuning LMs for specific domains may involve adapting a trained language model to generate domain-specific text and/or initiate or perform domain-specific tasks. This process allows the LM to better understand and generate content that aligns with a particular field or subject matter of interest.

Notably, LMs are sometimes distinguished as between a “large” LM (LLM) and a “small” LM (SLM) based on the size and complexity of the model, which affects their capabilities and applications. LLMs are often characterized by their large number of parameters, ranging from hundreds of millions to trillions of parameters. The extensive scale of LLMs enables them to capture complex language patterns and nuances. Due to their size and comprehensive training, LLMs exhibit excellent language understanding and generation abilities. However, LLMs require significant computational resources for both training and fine-tuning because of both the amount of data required for training, as well as the extensive scale of the underlying model parameters that must be updated during the training or fine-tuning process. These computational resource include, for example, powerful processing hardware such as multiple GPUs or TPUs and substantial memory and storage capacity.

Retrieval augmented generation (RAG) is another approach that combines and orchestrates LM functionality with other sources of knowledge for overcoming the aforementioned short-comings associated with general-purpose LMs. Like fine-tuning, RAG also adapts an LM to specific knowledge that is not encoded in its training data. For example, RAG-enhanced LM systems can expand a model's generative capabilities by configuring the model to access external datasets outside its original training data. These external datasets can comprise data related to dynamic knowledge, domain-specific knowledge, and previously-acquired knowledge that has been lost. Models configured with RAG techniques are able to generate new content based on the user prompt and additional content retrieved, while still leveraging patterns learned from its original training data.

To implement RAG, data is indexed and stored in a database that allows for data retrieval. The data can be unstructured like text or structured like knowledge graphs. In some instances the data is encoded or vectorized to produce corresponding embeddings. Next, in response to receiving a user prompt, a data retrieval component works to select the most relevant datasets from the content databases. The relevant datasets can be retrieved by using vector comparison techniques based on comparing the vector representations of the underlying data and documents. These retrieved datasets will be used to augment the original user prompt, so that the model is able to generate new content based on the retrieved data and user prompt.

RAG can be used to improve the accuracy and reliability of LMs by providing access to additional content from external data sources that contain more up-to-date data than the training data used to train the model, or that contain domain-specific data (as compared to training data which is usually domain-independent). By implementing RAG, models are able to generate responses to user prompts that are more customized to the user domain. Additionally, the quality of the responses is improved because the model is able to pull content from vetted sources, meaning not only will the response be more relevant to the user prompt, it will also be more accurate. Beneficially, RAG allows a system to leverage the capabilities of an LM, notably even the extensive scale of an LLM model, without having to perform fine-tuning on the LM. By avoiding the need for additional training, RAG-enabled LMs do not require the extensive computational resources associated with fine-tuning of the model.

However, even though RAG reduces the amount of computational resource needed to adapt the model to updated or new domains, RAG-enabled LMs still experience technical problems in generating content related to these updated or new domains. For example, in some instances, a technical problem occurs when the RAG system will retrieve irrelevant or contradictory information that can degrade response quality, rather than enhance it. This can occur, for example, when the stored content is not indexed well, leading to improper vector comparison results.

Additionally, another technical problem of RAG-enabled LMs is that the LM may hallucinate connections between unrelated pieces of retrieved content when generating the new content in response to a user query, which can also degrade response quality. Unrelated content can be retrieved, for example, when the RAG system retrieves multiple content datasets where one content dataset comprises relevant information related to user query, while another content dataset comprises irrelevant information. When responses to user queries are degraded, the quality of the overall user experience with applications, like automated assistants, based on the RAG-enabled LMs is also degraded. This can lead to increased user escalation (e.g., users requesting the assistance of a live agent, instead of the automated assistant), which can in turn lead to expensive human-based resources that need to be used to help the user.

LMs also have limited working memory, also referred to as a context window. The context window determines the amount of tokens that the LM can access and process during inference (e.g., when generating a response to a prompt). This includes both the inputs (e.g., user query and any retrieved documents), as well as the memory space needed for generating the output. Thus, RAG systems must account for the limited context window when utilizing RAG content. This can lead to challenges in choosing which content to retrieve and how much of that content to include “in context” while processing a prompt. Thus, because of the limitations of the context window, RAG systems may have the technical problem of not being able retrieve all of the relevant information needed to generate the response to the user query, leaving out crucial information, or otherwise not retrieving the content that is most relevant to the user query.

Another technical problem of RAG, is the latency impact for response generation. For example, the additional content retrieval step, as well as the augmentation step based on the retrieved content, can induce increased latency when generating a response to a prompt. Additional latency means users must wait additional time to receive responses to their user queries, which can lead to a degradation in the user experience and failure to perform in conformance with a service level agreement (SLA).

Embodiments described herein overcome the aforementioned technical problems and improve upon the state of the art by introducing systems and methods for offline enhancement and indexing of stored content available for retrieval, as well as improved systems and methods for retrieving the enhanced content as part of response generation. One application of the enhanced offline RAG systems are for use in question-answer plugins. A question-answer plugin is a type of user interface that is configured for submitting and answering user queries. Question-answer plugins can also be referred as automated assistants or chatbots, which are configured to simulate conversations with human users and provide answers or perform tasks based on user queries.

In the context of a question-answer plugin, when users ask a question, the system tries to identify the right sources of content to aid in generating the response. Enhancing the content offline and improving the content retrieval process helps the RAG-enabled LM to generate higher quality, more relevant, more accurate, and more helpful responses to user queries, thereby also improving the overall user experience with the question-answer plugin. It should be appreciated that while the embodiments herein are described in reference to question-answer plugins, the present embodiments can be used in many different applications that rely on RAG-enabled LM content generation.

Accordingly, aspects herein related to systems and methods that leverage a combination of LMs to generate a set of synthetic queries that can be indexed offline with corresponding available content. A synthetic query is a query that has been generated by an LM that is configured to simulate actual user queries. In some aspects, the combination of LMs is configured as a dual-model system comprising a first LM and a second LM. The first LM is used to generate synthetic queries related to different content datasets available for retrieval. The second LM is used to evaluate and filter the synthetic queries based on the relevancy of the synthetic queries to the corresponding content datasets. In some instances, the first and second LMs are configured as LLMs to beneficially leverage the extensive scale associated with LLMs.

Embodiments described herein are able to access content databases that store different content datasets that are available for retrieval through indexing each content dataset. The content datasets comprise electronic content such as knowledge (e.g., information, statements, and facts) that can be used to answer or respond to a user query. The system identifies a particular content dataset and prompts the first LM to generate a set of synthetic queries. These synthetic queries comprise questions that are related to the content dataset, wherein the content dataset comprises knowledge that can be used to answer the synthetic queries. These synthetic queries are indexed to the corresponding content datasets and provide additional vector embeddings that can be used to retrieve content that is related to a real-time user query.

In some instances, the first LLM may generate one or more synthetic queries that are not actually relevant to the corresponding content dataset. Accordingly, the system employs the second LLM to evaluate the relevancy of the different synthetic queries and filter out irrelevant synthetic queries. By filtering out irrelevant synthetic queries, only relevant synthetic queries of the set of synthetic queries initially generated are indexed with the corresponding content datasets.

Accordingly, during real-time content retrieval, the system will not only compare the vector embeddings of the real-time user query the with vector embeddings of the content datasets, but also will be able to compare the vector embeddings of the real-time user query with the vector embeddings of the relevant synthetic queries that are indexed with content datasets. By implementing RAG techniques with enhanced offline content in this manner, embodiments described herein improve upon the accuracy and reliability of RAG-enabled LM techniques and overcome technical problems associated with conventional RAG techniques. Embodiments described herein beneficially mitigate the technical problem of retrieving irrelevant content. For example, the indexing of the stored content is enhanced by indexing relevant synthetic queries with corresponding stored content. This enhances RAG by providing additional point of validation to ensure that the retrieved content is relevant to the user query because the vector embeddings of the user queries are now compared to both the vector queries of the stored content and the vector embeddings of the relevant synthetic queries. This allows the enhanced RAG to retrieve relevant content and avoid retrieving irrelevant content.

Embodiments herein beneficially mitigate the technical problem of generating hallucinations based on irrelevant content. In the context of language models, a hallucination is when the model generates content that is false, misleading, or ungrounded in reality, but presents it as statement as factual information. This phenomenon may occur when an LM produces outputs that are not based on its training data or are incorrectly decoded, resulting in nonsensical or inaccurate responses. Such phenomenon can be mitigated or prevented using one or more aspects of the present disclosure.

For example, as described above, because the content retrieved by the enhanced RAG is validated as being relevant by comparing the user queries to both the content and the relevant synthetic queries, the enhanced RAG is more likely to only retrieve relevant and similar content. This reduces the likelihood that irrelevant and relevant content is retrieved at the same time. Whereas any dissonance between the irrelevant and relevant content may have induced the LM to hallucinate, because the enhanced RAG is retrieving only relevant content, the LM is less likely to hallucinate during response generation because it will not get confused or need to reconcile differences between irrelevant and relevant content.

Embodiments herein beneficially mitigate the technical problem associated with limited context windows of the underlying LM. For example, embodiments herein are able to better determine which content is actually relevant to the user query causing the enhanced RAG to efficiently choose which content to retrieve. Because the enhanced RAG is able to determine the most relevant (or more relevant than a conventional RAG achieves) out of the available stored content, the context window is not unnecessarily filled up with irrelevant content or extra content, that may be related to the user query, but is not needed to actually generate a response to a user query. Thus, embodiments herein avoiding issues that arise with maxing out the context window of the LM.

Embodiments herein beneficially mitigate the technical problem of increased latency associated with conventional RAG. Embodiments herein can achieve reduced latency in generating responses to user queries because relevant content can be identified and retrieved more quickly and efficiently since the vector embeddings for the user query may be even more similar to (and therefore easier to identify as a match) to the vector embeddings of the relevant synthetic queries, than the vector embeddings of the corresponding content datasets. Notably, because the generating and indexing of synthetic queries with the stored content is performed offline, it doesn't impact the existing latency times associated with implementing RAG during real-time serving.

Thus, this dual-model RAG system beneficially improves the efficiency of retrieving the available content, as well as improves the relevancy of the content that is selected for retrieval. By improving the relevancy of retrieved content, the quality and accuracy of responses generated for user queries are improved, the overall user experience is also improved. Additionally, with improved response generation, systems also reduce the likelihood that users will escalate beyond the automated assistant, avoiding the need for expensive live agent interaction with the user.

Additional technical benefits are achieved by performing a deduplication process on the indexed synthetic queries in order to identify and remove duplicate synthetic queries that have been indexed as corresponding to the same content dataset. This reduces the amount of computational resources needed to perform content retrieval, by reducing the number of vector embeddings that are analyzed during a vector comparison step. Further technical benefits are achieved by implementing a feedback loop based on user feedback on the enhanced responses where the feedback loop helps to improve the underlying LMs responsible for generating and filtering synthetic queries.

### Example User Interfaces

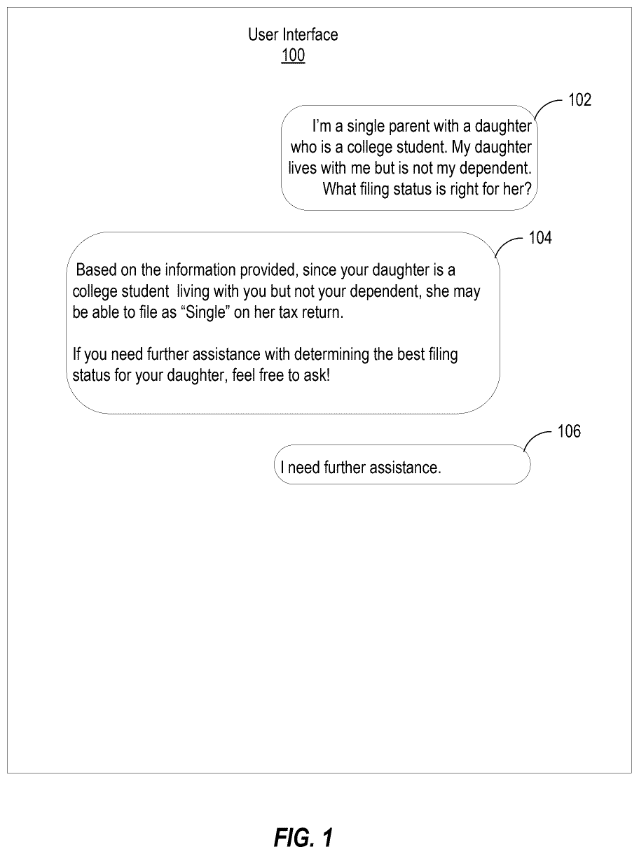

FIG. 1 depicts a user interface 100 configured as a question-answer plugin that can be integrated into a software platform or website. User interface 100 is configured to receive user queries that comprise questions or instructions to perform a task. In response to receiving user queries, user interface 100 then presents responses to those user queries. In some instances, the responses are generated by a machine learning model, such as a general-purpose LM. For example, a user submits user query 102 (“I'm a single parent with a daughter who is a college student. My daughter lives with me but is not my dependent. What filing status is right for her?”). A system prompt corresponding to the user query is automatically generated, wherein the system prompt is configured to instruct an LM to generate a response to the user query 102. User query 102 is then transmitted to the LM, along with a corresponding prompt, to cause the LM to generate response 104 to user query 102. Response 104 is then transmitted to user interface 100. For example, user interface 100 is shown displaying response 104 (“Based on the information provided, since your daughter is a college student living with you but not your dependent, she may be able to file as “Single” on her tax return. If you need further assistance with determining the best filing status for your daughter, feel free to ask!”). The user can then submit an additional user query or other type of user input (e.g., user input 106: “I need further assistance.”) to continue or end the conversation within user interface 100.

As described above, there are some technical problems associated with generating responses with a general-purpose LM. Even if the general-purpose LM has been fine-tuned and/or equipped with RAG, the LM may still be limited in its ability to generate responses to user queries. For example, while response 104 includes relevant information in response to user query 102, namely the suggestion that the user's daughter “may be able to file as ‘Single’ on her tax return,” response 104 does not provide additional context or other instructions the user might need to help her daughter file with the right filing status. For example, someone may need to know that if their daughter is going to claim “Single” on her tax return, they cannot claim their daughter as a dependent on their tax return. Even if “Single” may be the correct filing status for the daughter under the circumstances, that filing status would no longer be correct if a parent were to claim the daughter as a dependent on their tax return. Thus, without these additional considerations, the user may not have all of the information that they need to make an informed decision.

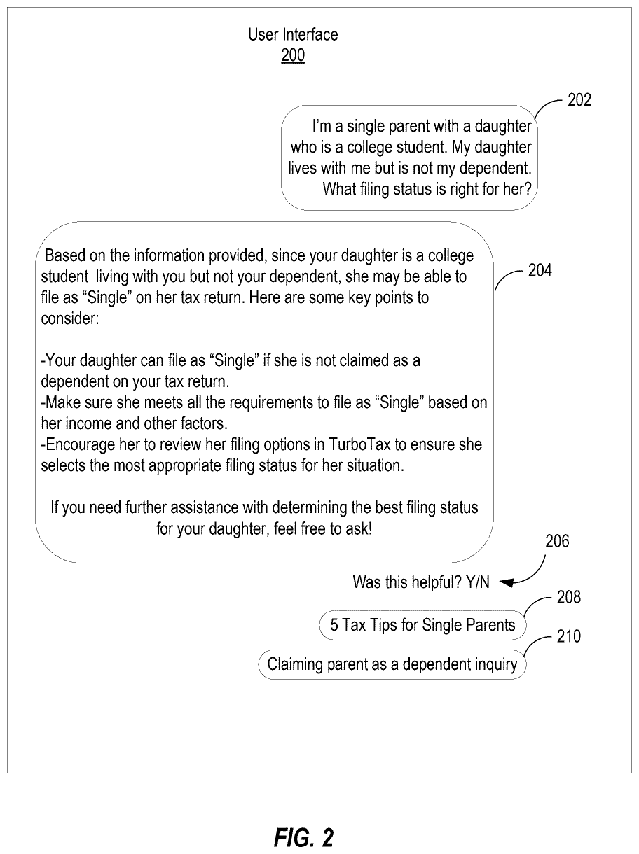

FIG. 2 depicts user interface 200 that has received user query 202, which mirrors user query 102. However, in this example the responses, also referred to as enhanced responses herein, are generated by an enhanced RAG-enabled LM. The enhanced RAG-enabled LM generates responses based on content that was retrieved by comparing vector embeddings of user query 202 with a combination of (1) vector embeddings of different content datasets and (2) vector embeddings of relevant synthetic queries corresponding to the different content datasets. Thus, the enhanced RAG system is able to retrieve more relevant content to in response to user query 202 from the than a conventional RAG system, which beneficially improves the quality of responses to user queries.

For example, FIG. 2 depicts enhanced response 204, which in addition to the content of response 104 in FIG. 1, further includes “key points to consider.” The additional content is provided by the enhanced RAG system, which makes more relevant information available to the LM when generating a response to user query 202. These additional points are helpful for the user to consider and decide if “Single” is the right filing status for her daughter, thereby improving the user experience with the question-answer plugin and reducing the likelihood of the user escalating the interaction to a live agent. Additional content can be included as part of enhanced response 204 because the enhanced RAG-enabled LM receives higher quality (e.g., more relevant to the user query 202) content than a conventional RAG-LM system. The enhanced RAG-enabled LM is able to access this higher quality content based on retrieving content whose vector embeddings and corresponding synthetic query vector embeddings match the vector embeddings of the user query 202. This higher quality content is then used to generate enhanced response 204, which in turns allows the enhanced RAG-enabled LM to generate a higher quality response than a conventional RAG-LM system because the underlying content (retrieved through enhanced RAG) is more relevant to the user query 202 than the content retrieved through conventional RAG.

User interface 200 is also configured to receive user feedback 206 regarding whether enhanced response 204 was helpful or not (“Was this helpful? Y/N”). While depicted as a text selection in this example, user feedback 206 could also be configured to use iconography (e.g., thumb up and thumb down icons) to allow the user to select to indicate whether enhanced response 204 was helpful.

Additionally, user interface 200 displays links to additional sources of information that the user can access. For example, user interface 200 displays suggestion chip 208 (“5 Tax Tips for Single Parents”) and suggestion 210 (“Claiming parent as a dependent inquiry”), which a user may select to receive more information.

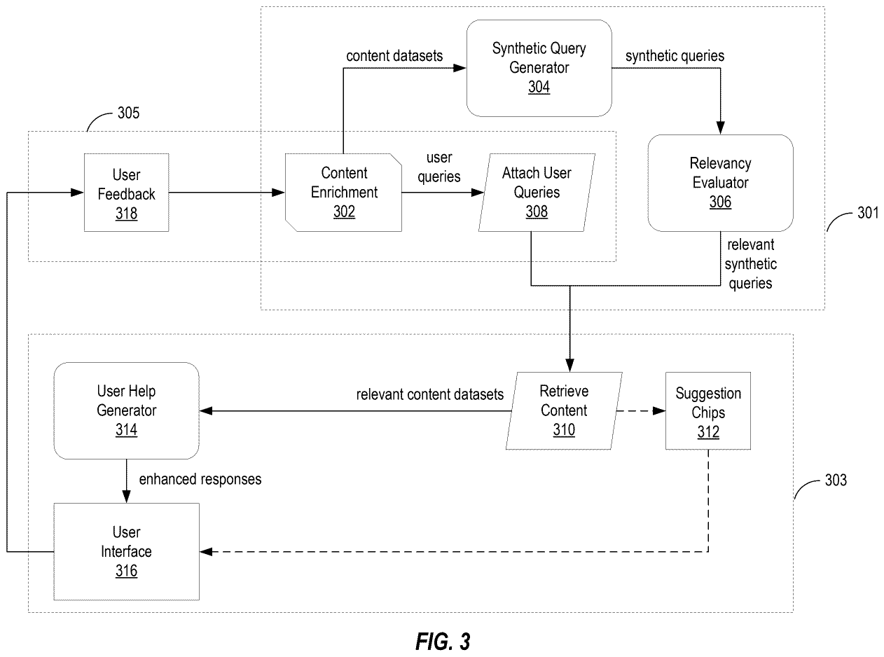

Embodiments described herein with reference to FIGS. 3-11 discuss in more detail how to improve LM responses to user queries, such as described with respect to the example of FIG. 2.

FIG. 3 depicts a flowchart for an enhanced RAG-enabled LM system. The enhanced RAG-enabled LM system generally comprises three sub-systems, including an offline dual-model system 301 for generating and indexing synthetic queries, a run-time system 303 for retrieving content and generating responses to user queries based on the retrieved content, and a fine-tuning system 305 for integrating a feedback loop for the enhanced RAG-enabled LM system to improve one or more of the underlying models of any of the aforementioned sub-systems.

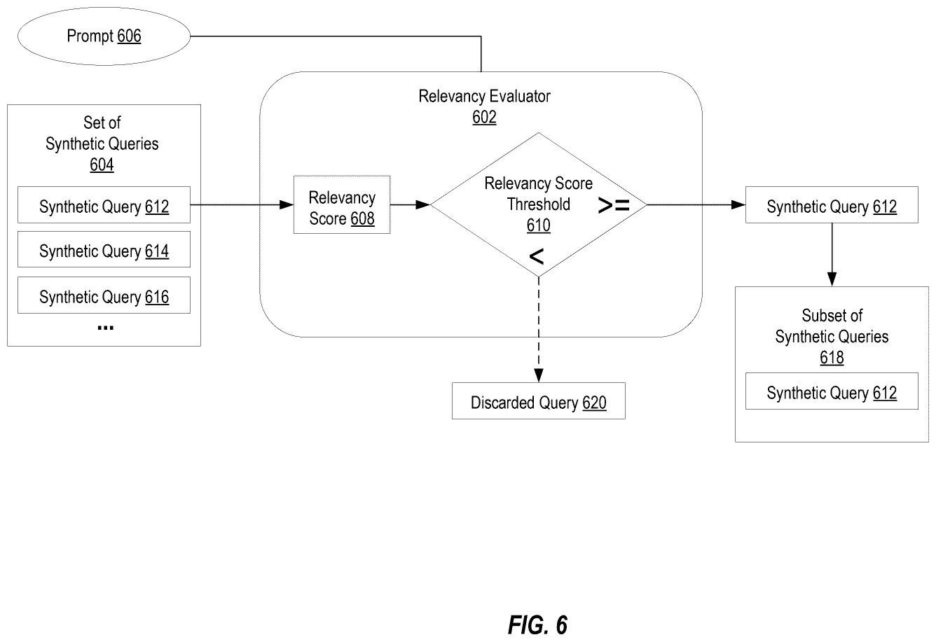

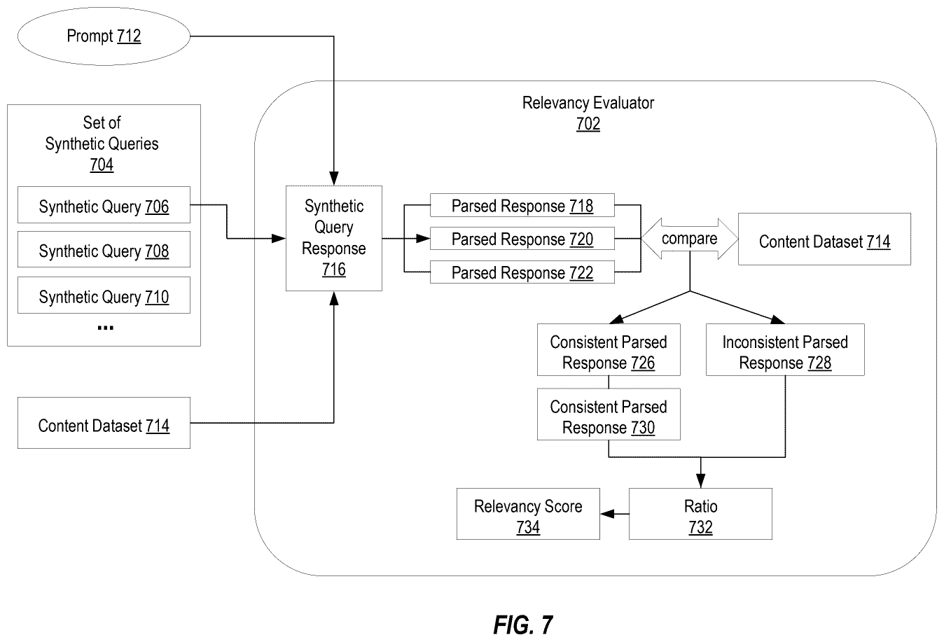

The offline dual-model system 301 in this example comprises a synthetic query generator 304 and relevancy evaluator 306, which are configured as LMs. Synthetic query generator 304 is configured to generate new synthetic queries based on corresponding content datasets indexed in a content database. The content database is configured to store electronic content that is segmented into different content datasets and comprises knowledge, such as information and context, related to different user queries. For example, the knowledge can be used to generate responses and answers to user queries. Relevancy evaluator 306 is configured to generate relevancy scores for synthetic queries, classify synthetic queries as relevant or irrelevant based on the relevancy scores, and filter out irrelevant synthetic queries, described in more detail with respect to FIGS. 6-7.

Initially, in order to facilitate the different functionalities of the offline dual-model system 301, content enrichment component 302 is configured to index and store one or more content datasets in a content database. In some instances, the content datasets are initially enriched with metadata. The metadata comprises information related to the content datasets such as timestamp, product information, such as product type, and platform information, such as platform type, corresponding to the content datasets. Metadata can also comprise user preferences and user feedback.

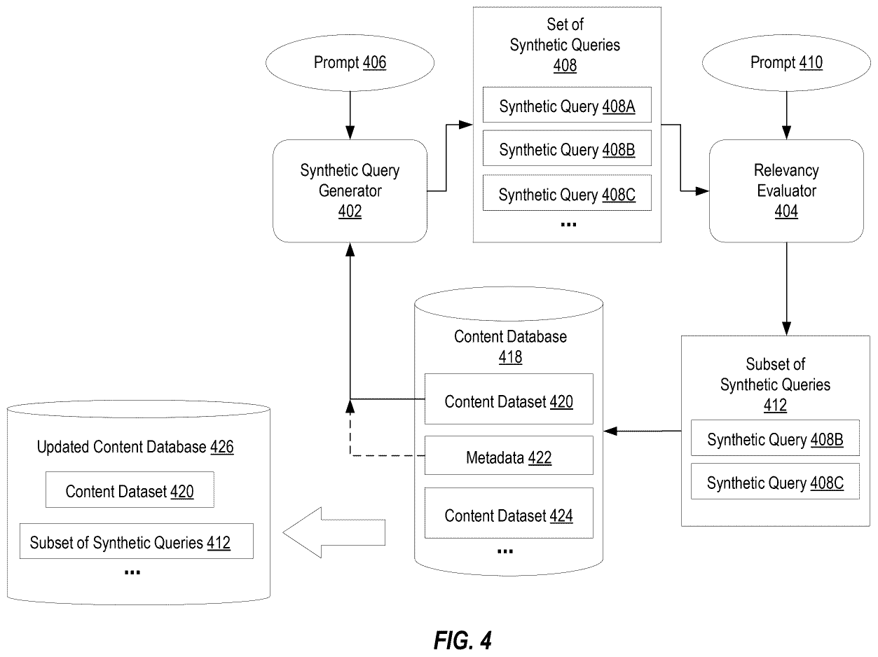

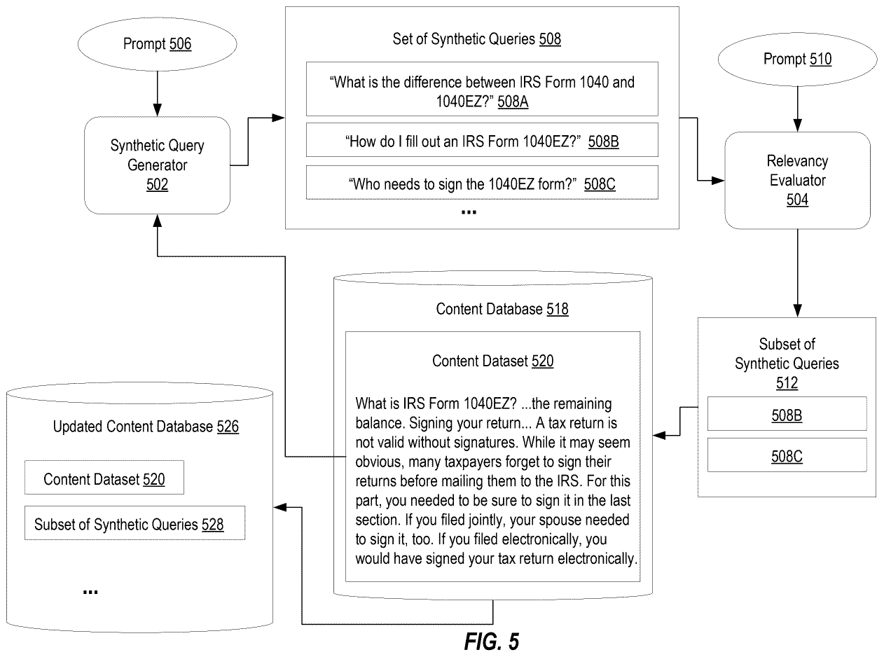

Synthetic query generator 304 then accesses content datasets and corresponding metadata (e.g., from content enrichment component 302) and generates synthetic queries for the different content datasets (described in more detail with reference to FIG. 4-5). The synthetic queries comprise simulated questions that can be answered with knowledge extracted from the various content datasets.

Subsequently, relevancy evaluator 306 evaluates the synthetic queries and determines how relevant the synthetic queries are to the corresponding content datasets. In some instances, the relevancy evaluator 306 determines relevancy scores for the synthetic queries and filters out the irrelevant synthetic queries based on comparing the relevancy scores to a relevancy score threshold. In some instances, the relevancy score threshold is identified by accessing historical evaluation data of the offline dual-model system 301, identifying a current quality score associated with the offline dual-model system 301, and determining a new value for the relevancy score threshold that will cause the dual-model system 301 to achieve a new quality score that is higher than the current quality score. Additionally, or alternatively, in some instances, the relevancy score threshold is identified by accessing historical evaluation data of user help generator 314, identifying a current quality score associated with user help generator 314, and determining a new value for the relevancy score threshold that will cause user help generator 314 to achieve a new quality score that is higher than the current quality score.

Thus, the output of the offline dual-model system 301 comprises relevant synthetic queries that can be indexed with the corresponding content datasets as part of a second functionality associated with content enrichment component 302. The generation of synthetic queries by the synthetic query generator 304 and filtering by the relevancy evaluator 306 may be performed offline, like conventional RAG systems, so that any latency associated with using RAG systems is not increased.

FIG. 3 also depicts run-time system 303 for retrieving content and generating responses to user queries based on the retrieved content. For example, during run-time, in response to receiving a user query at user interface 316, retrieve content component 310 retrieves content datasets from a content database that are related to the user query. The content datasets are retrieved based on a determination that the content datasets are relevant to the user query. This relevancy determination may be achieved, for example, by comparing the vector embeddings (e.g., using cosine similarity, Euclidean distance, dot product similarity, Manhattan distance, hamming distance, Jaccard similarity, etc.) of a user query to the vector embeddings of the content datasets and the vector embeddings of the relevant synthetic queries that were indexed with the corresponding content datasets. The user help generator 314 then extracts knowledge from the relevant content datasets to generate an enhanced response (e.g., enhanced response 204) to the user query. The enhanced response is then transmitted to user interface 316 (e.g., user interface 200).

In some instances, the retrieve content component 310 also retrieves suggestion chips 312 (e.g., suggestion chip 208, suggestion chip 210 of FIG. 2). Suggestion chips 312 are model outputs that comprise additional suggestions to the user. Suggestions may be configured as text bubbles displayed within the chatbot user interface and comprise corresponding selectable links to external content and additional resources related to the user query submitted by the user. Suggestion chips 312 are also transmitted to the user interface 316 and displayed to the user. The user can further interact with the suggestion chips 312 by clicking on the suggestion chips which will display new content based on the links to external content and additional resources corresponding to the selected suggestion chip. In some instances, suggestions chips 312 are configured to allow users to further prompt the user help generator 314 to retrieve additional information related to the user query. For example, when a user selects a suggestion chip, a new prompt corresponding to the suggestion chip can be automatically provided to the user help generator 314. In response, the user help generator 314 generates a new response and transmits the new response to be displayed at the user interface.

After viewing the enhanced response at the user interface 316, the user is able to provide user feedback 318 (e.g., user feedback 206 of FIG. 2) at user interface 316 facilitated by the fine-tuning system 305. The user feedback 318 comprises an indication of how helpful the enhanced response was to the user in responding to their user query. If the user feedback 318 was positive (i.e., meaning that the user determined that the enhanced response was helpful in answering/responding to the user query), the user query is also indexed (e.g., attach user queries component 308) with the relevant content datasets that were received by the user help generator 314 to generate the enhanced response. In this manner, content datasets can be retrieved based on comparing the vector embeddings of new user queries to vector embeddings of previously indexed user queries, the vector embeddings of the corresponding content datasets, and the vector embeddings of the synthetic queries that are also indexed with the corresponding content datasets. By providing multiple categories of vector embeddings, the run-time system 303 is able to retrieve content datasets that are more relevant to a new user query than conventional RAG systems.

FIG. 4 depicts a flowchart of a process for updating a content database with relevant synthetic queries (e.g., as facilitated by offline dual-model system 301 of FIG. 3).

In particular, FIG. 4 depicts a synthetic query generator 402 that is configured to access content and generate synthetic queries corresponding to the content. For example, synthetic query generator 402 accesses content database 418, which comprises one or more content datasets (e.g., content dataset 420, content dataset 424) and corresponding metadata 422. Metadata 422 comprises information related to the content datasets such as timestamp information, product type, and platform type corresponding to the content datasets. While content database 418 is shown comprising two content datasets, content database 418 can comprise any number of content datasets. Content datasets are extracted from larger corpuses of content, indexed, and stored in content database 418. Generally, content datasets such as 420 and 424 comprise knowledge (i.e., information, statements, and facts) that can be used to generate responses to user queries.

Synthetic query generator 402 first accesses content dataset 420 to generate a set of synthetic queries 408 based on content dataset 420. Additionally, a system-level prompt (e.g., prompt 406) is automatically generated by synthetic query generator 402 or generated by another LM and accessed by synthetic query generator 402 (if the system-level prompt is pre-generated prior to run-time of the synthetic query generator 402). Prompt 406 is configured to cause the synthetic query generator 402 to generate the set of synthetic queries 408 for content dataset 420. The set of synthetic queries 408 comprises one or more synthetic queries (e.g., synthetic query 408A, synthetic query 408B, and synthetic query 408C). A synthetic query is a query that is generated by an LM or other machine-based system, as opposed to a user query which is created and submitted by a human user. The set of synthetic queries 408 comprise one or more synthetic queries that comprise one or more questions that can be answered based on knowledge included in the corresponding content dataset (e.g., content dataset 420 or other content dataset indexed in content database 418).

The set of synthetic queries 408 is then transmitted to relevancy evaluator 404. Relevancy evaluator 404 is configured to analyze the set of synthetic queries and filter out synthetic queries that were generated, but which are not relevant to the corresponding content dataset 420. Even though prompt 406 instructs the synthetic query generator 402 to generate a set of synthetic queries 408 that is relevant to the content dataset 420, in some instances, synthetic query generator 402 may still generate one or more irrelevant synthetic queries of the set of synthetic queries 408. In some instances, the irrelevant queries comprise hallucinations generated by the LM. Accordingly, prompt 410 is configured to cause relevancy evaluator 404 to analyze the set of synthetic queries 408 and filter out irrelevant synthetic queries.

After discarding irrelevant synthetic queries (e.g., synthetic query 408A), relevancy evaluator 404 outputs a subset of the set of synthetic queries 412 that comprise only relevant synthetic queries (e.g., synthetic query 408B, synthetic query 408C). The content database 418 is then updated with the subset of synthetic queries 412 by indexing the subset of synthetic queries 412 along with the corresponding content datasets. For example, as shown in FIG. 4, the subset of synthetic queries 412 is indexed with content dataset 420. In this manner, the enhanced RAG-enabled LM system will be able to access the updated content database 426 to perform enhanced RAG and return content relevant to a user query. For example, content dataset 420 can be identified as being relevant to a user query by comparing vector embeddings of the user query to vector embeddings of content dataset 420 and/or vector embeddings of subset of synthetic queries 412 that correspond to content dataset 420.

FIG. 5 depicts an example process of FIG. 4 with examples of synthetic queries and content datasets.

For example, content database 518 (e.g., content database 418) comprises content dataset 520 (e.g., content dataset 420). Content dataset 520 comprises an excerpt of text about requirements for signing a particular tax form. For example, content dataset 520 comprises:
“What is IRS Form 1040EZ? . . . the remaining balance. Signing your return . . . A tax return is not valid without signatures. While it may seem obvious, many taxpayers forget to sign their returns before mailing them to the IRS. For this part, you needed to be sure to sign it in the last section. If you filed jointly, your spouse needed to sign it, too. If you filed electronically, you would have signed your tax return electronically.”

Content dataset 520 is then transmitted to synthetic query generator 502 (e.g., synthetic query generator 402). Prompt 506 (e.g., prompt 506) is also transmitted to synthetic query generator 502. Prompt 506 is configured to cause synthetic query generator 502 to generate a set of synthetic queries 508 (e.g., set of synthetic queries 408) comprising a plurality of different synthetic queries (e.g., synthetic query 508A, synthetic query 508B, synthetic query 508C). Synthetic query 508A comprises a question: “What is the difference between IRS Form 1040 and 1040EZ”. Synthetic query 508B comprises a question “How do I fill out an IRS Form 1040EZ.” Synthetic query 508C comprises a question: “Who needs to sign the 1040EZ form?”

The set of synthetic queries 508 is transmitted to the relevancy evaluator 504 (e.g., relevancy evaluator 404). Prompt 510 (e.g., prompt 410) is also transmitted to relevancy evaluator 504 and is configured to cause relevancy evaluator 504 to evaluate the set of synthetic queries 508 and filter out irrelevant queries. Here, content dataset 520 comprises knowledge about requirements for signing a 1040EZ form. Synthetic query 508B and synthetic query 508C both comprise questions related to signing a 1040EZ form. However, synthetic query 508A comprises a question related to differences between the 1040 and 1040EZ form. Thus, relevancy evaluator 504 discards synthetic query 508A because it is irrelevant to content dataset 520 based on not being related to signing requirements of the 1040EZ form. Thus, relevancy evaluator 504 outputs a subset of synthetic queries 512 (e.g., subset of synthetic queries 412) that comprises relevant synthetic queries (e.g., synthetic query 508B and synthetic query 508C). As previously mentioned, the generation of the subset of synthetic queries 512 is described in more detail with respect to FIG. 6. The subset of synthetic queries 512 is then indexed with content dataset 520 to which is corresponds. Accordingly, FIG. 5 depicts updated content database 526 (e.g., updated content database 426) comprising content dataset 520 indexed with subset of synthetic queries 528.

Like in FIG. 4, here, the enhanced RAG-enabled LM system will be able to access the updated content database 526 to perform enhanced RAG and return content relevant to a user query. For example, content dataset 520 can be identified as being relevant to a user query by comparing vector embeddings of the user query to vector embeddings of content dataset 520 and/or vector embeddings of subset of synthetic queries 512 that correspond to content dataset 520.

FIG. 6 depicts an example process for evaluating and filtering synthetic queries by a relevancy evaluator configured to generate relevancy scores for synthetic queries and filter out irrelevant synthetic queries based on comparing the relevancy scores corresponding to the synthetic queries to a relevancy score threshold.

In particular, FIG. 6 depicts relevancy evaluator 602 receiving a set of synthetic queries 604. The set of synthetic queries 604 comprises a plurality of synthetic queries. For example, the set of synthetic queries 604 is shown comprising: synthetic query 612, synthetic query 614, and synthetic query 616. Prompt 606 is also transmitted as input to relevancy evaluator 602. It should be appreciated that relevancy evaluator 602 is representative of relevancy evaluator 504, set of synthetic queries 604 is representative of the set of synthetic queries 508, and prompt 606 is representative of prompt 506 depicted in FIG. 5. Prompt 606 is configured to cause the relevancy evaluator 602 to generate relevancy scores and filter out irrelevant synthetic queries based on relevancy scores not meeting a relevancy score threshold 610.

As described above, in some instances, the relevancy score threshold 610 is identified by accessing historical evaluation data of the synthetic query generator, identifying a current quality score associated with the offline dual-model system 301, and determining a new value for the relevancy score threshold that will cause the dual-model system 301 to achieve a new quality score that is higher than the current quality score. Additionally, or alternatively, in some instances, the relevancy score threshold is identified by accessing historical evaluation data of user help generator 314, identifying a current quality score associated with user help generator 314, and determining a new value for the relevancy score threshold that will cause user help generator 314 to achieve a new quality score that is higher than the current quality score.

To increase the overall relevancy of the subset of synthetic queries, the relevancy score threshold can be increased to provide a more stringent filtering process of the set of synthetic queries. Alternatively, in some instances, the relevancy score threshold can be decreased if no synthetic queries generated by the synthetic query generator pass the current relevancy score threshold to allow for more synthetic queries to be indexed with the corresponding content datasets. However, if all of the synthetic queries generated by the set of synthetic queries are discarded based on its relevancy scores not meeting the relevancy score threshold, it may be an indication that the synthetic query generator needs to be fine-tuned in order to generate more relevant synthetic queries that will pass the relevancy score threshold filter.

For example, relevancy evaluator 602 evaluates synthetic query 612 to determine how relevant synthetic query 612 is to the content dataset based on which the synthetic query 612 was generated. Here, relevancy evaluator 602 generates relevancy score 608 for synthetic query 612. In some instances, the relevancy score 608 is a relevant or not relevant label based on a binary output of 1 or 0, a percentage, or a value selected from a scale of values (e.g., 0 to 1; 1-10; or other numbered scale). The generation of relevancy scores is described in further detail with respect to FIG. 7 below.

Relevancy score 608 is then compared to the relevancy score threshold 610. If relevancy score 608 meets or exceeds relevancy score threshold 610, synthetic query 612 is retained as part of the subset of synthetic queries 618 that are indexed with the corresponding dataset. Alternatively, if relevancy score 608 does not at least meet relevancy score threshold 610, synthetic query 612 is discarded (e.g., discarded query 620) and is not indexed with the corresponding content dataset. In this manner, the offline dual-model system 301 retains only those synthetic queries that are actually relevant to the corresponding content dataset.

FIG. 7 depicts a flowchart of a process for generating relevancy scores for synthetic queries. For example, relevancy evaluator 702 receives as input, content dataset 714, set of synthetic queries 704, and prompt 712. The set of synthetic queries comprises a plurality of synthetic queries (e.g., synthetic query 706, synthetic query 708, and synthetic query 710) that comprise questions that can be answered using knowledge extracted from content dataset 714. In this example, the set of synthetic queries 704 were generated based on content dataset 714 (e.g., by using synthetic query generator 402).

To generate a relevancy score for synthetic query 706, relevancy evaluator 702 generates synthetic query response 716 that comprises a response to synthetic query 706. Synthetic query response 716 is then parsed into a plurality of parsed responses (e.g., parsed response 718, parsed response 720, parsed response 722).

Content dataset 714 also comprises a set of statements that may or may not correspond to one or more different parsed responses. A statement is a sentence or phrase that comprises a fact, opinion, question, or otherwise provides information about a knowledge domain associated with the content dataset. To determine if any of the statements correspond, the the parsed responses are compared with statements included in the content dataset 714. For example, parsed response 718 is compared to the statements included in content dataset 714 to determine whether parsed response 718 matches at least one statement in content dataset 714. As shown in FIG. 7, parsed response 718 matches at least one statement in content dataset 714 and is identified as consistent parsed response 726. Parsed response 722 also matches at least one statement included in content dataset 714 and is identified as consistent parsed response 730. In contrast, parsed response 720 does not match any of the statements in content dataset 714. Accordingly, parsed response 720 is identified as inconsistent parsed response 728.

In summary, relevancy evaluator 702 identifies a total of three statements corresponding to three parsed responses. Of the three statements, two statements are consistent with content dataset 714 and one statement is inconsistent with content dataset 714. Subsequent to determining which statements included in the parsed responses are consistent or inconsistent, relevancy evaluator 702 determines a ratio of consistent parsed responses in proportion to the total number of parsed responses. In the present example, ratio 732 is determined to be 2/3. The relevancy score 734 is then generated based on ratio 732 and identified as the relevancy score corresponding to synthetic query 706. In some instances, the relevancy score 734 is the same as ratio 732. In some instances, relevancy score 734 is a percentage conversion based on ratio 732. In some instances, relevancy score 734 is a scaled version of ratio 732 (e.g., converted to a value between 1 and 10). The relevancy score 734 is configured in a format that is compatible with comparing the relevancy score 734 to the relevancy score threshold (e.g., relevancy score threshold 610). Relevancy score 734 is then compared with a relevancy score threshold. If relevancy score 734 at least meets the relevancy score threshold, synthetic query 706 is identified as a relevant synthetic query and indexed with content dataset 714. If relevancy score 734 does not meet the relevancy score threshold, then synthetic query 706 is identified as an irrelevant synthetic query and is discarded. In this manner, the synthetic queries are filtered to retain only the relevant synthetic queries to index with the corresponding content datasets.

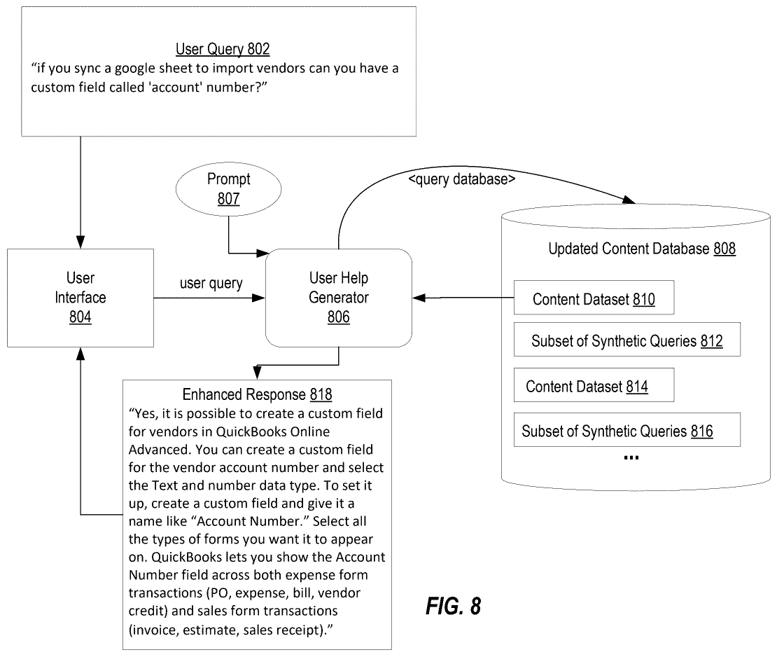

FIG. 8 depicts a flowchart of a process for generating enhanced responses to user queries (e.g., using run-time system 303 of FIG. 3).

In particular, FIG. 8 depicts user interface 804 (e.g., user interface 316) that is configured to receive user input and display enhanced responses to a user in response to the user input. For example, user interface 804 receives user query 802 that comprises a question that the user would like answered (e.g., “if you sync a numeric sheet to import vendors can you have a custom field called ‘account’ number?”).

User query 802 is then transmitted from user interface 804 to user help generator 806. User help generator 806 is configured as an LM trained to generate responses to user queries based on LM generative capabilities and content retrieved through enhanced RAG described herein. In addition to user query 802, prompt 807 is also transmitted to user help generator 806. Prompt 807 is a system prompt that is automatically generated in response to detecting that user query 802 has been received at user interface 804. Prompt 807 is configured to cause user help generator 806 to generate enhanced responses to user queries based on content retrieved through enhanced RAG.

Content datasets are retrieved from content database 808 based on being relevant to user query 802. Content datasets are indexed with corresponding subsets of synthetic queries to facilitate improved retrieval of relevant content. For example, content dataset 810 is identified as being relevant to user query 802 and is transmitted to user help generator 806. Content dataset 810 is identified as being relevant to user query 802 by comparing vector embeddings of user query 802 to vector embeddings of content dataset 810 and/or vector embeddings of subset of synthetic queries 812 that correspond to content dataset 810. It should be appreciated that while only one content dataset 810 was identified as being relevant to user query 802, multiple content datasets of updated content database 808 may be identified as being relevant to user query 802 and transmitted to user help generator 806. User help generator 806 is then able to generated enhanced response 818 based on prompt 807, user query 802, and content dataset 810.

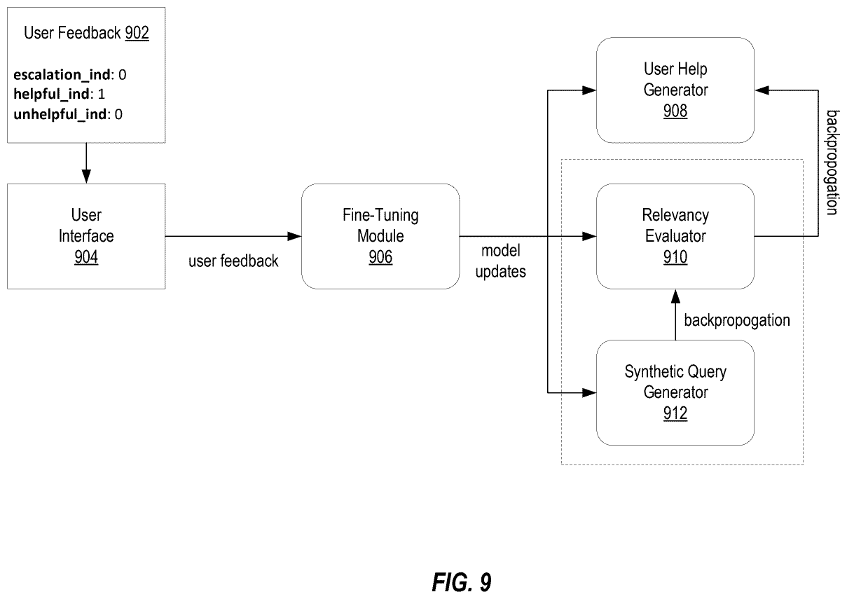

FIG. 9, depicts a flowchart of a process for implementing a feedback loop to improve one or more underlying models of offline dual-model system 301 and/or run-time system 303 described herein.

In particular, FIG. 9 depicts user feedback 902 (e.g., user feedback 206) being received at user interface 904 (e.g., user interface 200). User feedback 902 is received as additional user input related to a response (e.g., enhanced response 204) generated as an answer to a first user query (e.g., user query 202). As shown in FIG. 9, user feedback 902 comprises one or more of: an escalation indictor (e.g., “escalation_ind”), a helpfulness indicator (e.g., “helpful_ind”), and an unhelpfulness indicator (e.g., “unhelpful_ind”). The escalation indicator is returned as “0” if the user did not escalate the interaction with the question-answer plugin (e.g., user interface 200). If the user did escalate the interaction with the question-answer plugin (e.g., user interface 200) (i.e., the user did not request to be transferred to a live agent), then the escalation indicator is returned at “1”.

The unhelpfulness indicator is returned as 1 when the user submits user feedback, such as user feedback 902, that enhanced response 204 was unhelpful, wherein the helpfulness indicator is correspondingly returned as 0. On the other hand, if the user submits that enhanced response 204 was helpful, the unhelpfulness indicator is returned as 0, wherein the helpfulness indicator is conversely returned as 1.

User feedback 902, after being received at the user interface 904, is transmitted to fine-tuning module 906, which is configured to update one or more of the machine learning models being employed to generate responses to user queries based on the user feedback 902. For example, fine-tuning module 906 is configured to update one or more of: the user help generator 908, the relevancy evaluator 910, and/or the synthetic query generator 912. The fine-tuning module 906 updates a machine learning model by modifying one or more parameters corresponding to the machine learning model in order to train the machine learning model to generate updated output(s) that will result in more frequent positive helpfulness indicator scores associated with newly enhanced responses.

For example, fine-tuning module 906 is configured to update synthetic query generator 912 by training the synthetic query generator 912 to generate improved synthetic queries that have better relevancy to a user query than the synthetic query generator 912 was able to generate prior to being updated with user feedback 902. Additionally, fine-tuning module 906 is configured to update relevancy evaluator 910 by training the relevancy evaluator 910 to more accurately generate relevancy scores for synthetic queries, so that the relevancy evaluator 910 is able to more accurately filter out irrelevant queries and refrain from indexing irrelevant synthetic queries with the corresponding content datasets. Fine-tuning module 906 is also configured to update user help generator 908 by training user help generator 908 to generate improved responses to user queries by retrieving more extracting higher quality knowledge from the retrieved content datasets.

### Example Methods for Enhanced Generative Retrieval

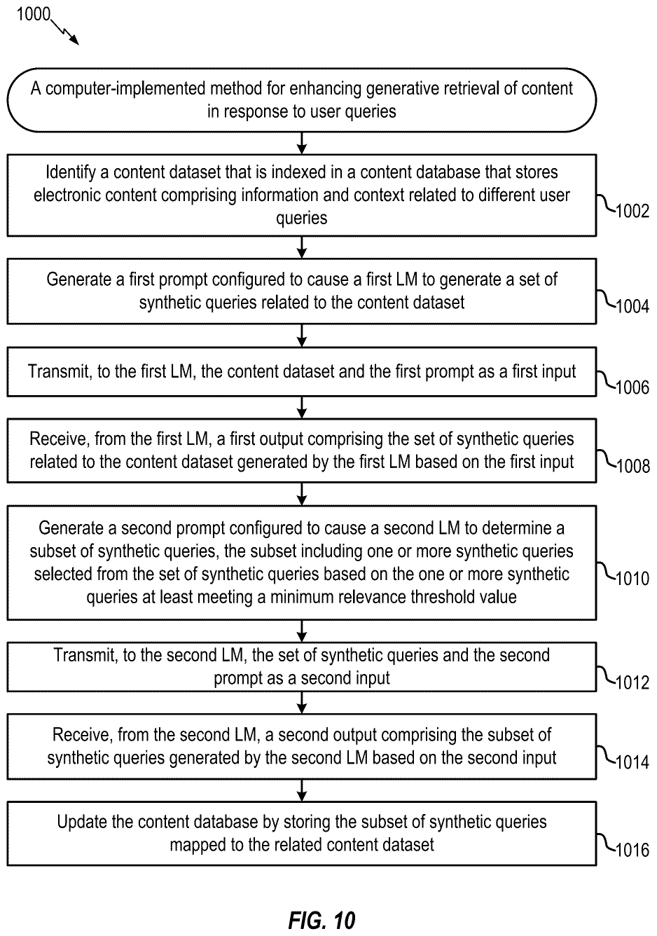

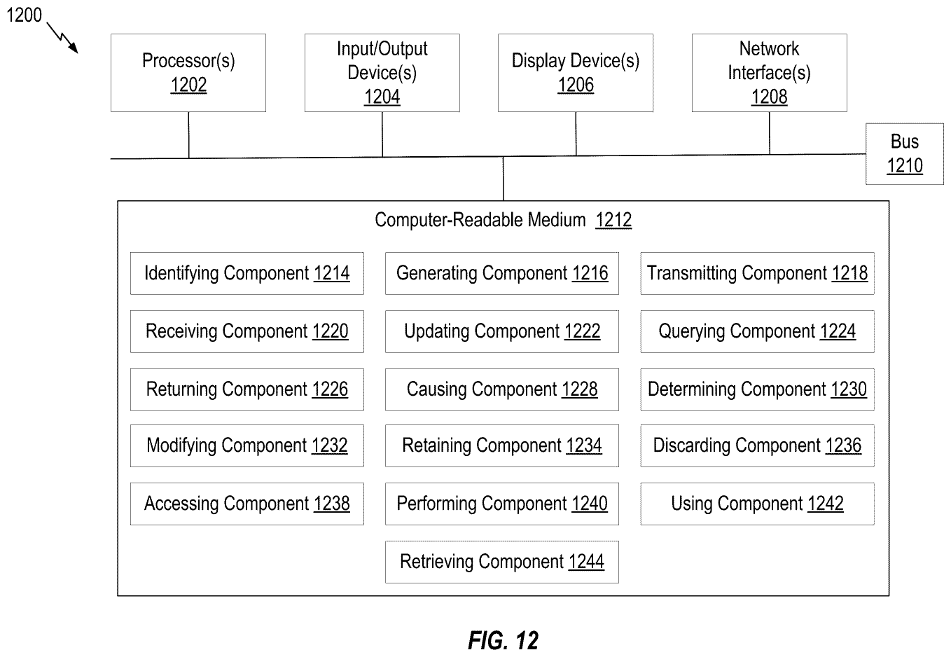

FIG. 10 depicts an example method 1000 for enhancing generative retrieval of content in response to user queries. In one aspect, method 1000 can be implemented by the processing system 1200 of FIG. 12.

Method 1000 starts at block 1002 with identifying a content dataset (e.g., content data 420) that is indexed in a content database (e.g., content database 418) that stores electronic content comprising information and context (e.g., content dataset 420, content dataset 424, and metadata 422) related to different user queries.

Method 1000 continues to block 1004 with generating a first prompt (e.g., prompt 406) configured to cause a first language model (LM) (e.g., synthetic query generator 402) to generate a set of synthetic queries (e.g., set of synthetic queries 408) related to the content dataset. These synthetic queries comprise questions that are related to the content dataset, wherein the content dataset comprises knowledge that can be used to answer the synthetic queries. These synthetic queries can be indexed to the corresponding content datasets and provide additional vector embeddings that can be used to retrieve content that is related to a real-time user query.

Method 1000 continues to block 1006 with transmitting, to the first LM, the content dataset and the first prompt as a first input.

Method 1000 continues to block 1008 with receiving, from the first LM, a first output comprising the set of synthetic queries related to the content dataset generated by the first LM based on the first input.

Method 1000 continues to block 1010 with generating a second prompt (e.g., prompt 410) configured to cause a second LM (e.g., relevancy evaluator 404) to determine a subset of the set of synthetic queries (e.g., subset of synthetic queries 412), the subset including one or more synthetic queries selected from the set of synthetic queries based on the one or more synthetic queries at least meeting a relevancy score threshold (e.g., relevancy score threshold 610). In some instances, the first LLM may generate one or more synthetic queries that are not actually relevant to the corresponding content dataset. Accordingly, the system employs the second LLM to evaluate the relevancy of the different synthetic queries and filter out irrelevant synthetic queries.

Method 1000 continues to block 1012 with transmitting, to the second LM, the set of synthetic queries and the second prompt as a second input. Because method 1000 is able to determine the most relevant (or more relevant than a convention RAG achieves) out of the available stored content, the context window is not unnecessarily filled up with irrelevant content or extra content, that may be related to the user query, but is not needed to actually generate a response to a user query. Thus, embodiments herein avoiding issues that arise with maxing out the context window of the LM.

Method 1000 continues to block 1014 with receiving, from the second LM, a second output comprising the subset of synthetic queries generated by the second LM based on the second input. By filtering out irrelevant synthetic queries and causing the second LM to generate the subset of synthetic queries, only relevant synthetic queries of the set of synthetic queries initially generated are indexed with the corresponding content datasets.

Method 1000 continues to block 1016 with updating the content database (e.g., updated content database 426) by storing the subset of synthetic queries stored with the related content dataset. Thus, by updating the content database in this manner, the system will not only be able to compare the vector embeddings of the real-time user query the with vector embeddings of the content datasets, but also will be able to compare the vector embeddings of the real-time user query with the vector embeddings of the relevant synthetic queries that are indexed with content datasets.

In some aspects, method 1000 further includes receiving a user query (e.g., user query 802) from a user interface (e.g., user interface 804).

In some aspects, method 1000 further includes, in response to receiving the user query, identifying one or more related synthetic queries included in the subset of synthetic queries stored in the content database (e.g., updated content database 808) that are related to the user query.

In some aspects, method 1000 further includes querying the content database using a combination of the user query and one or more related synthetic queries.

In some aspects, method 1000 further includes, in response to querying the content database, returning one or more content datasets (e.g., content dataset 810) selected from the content database that provide information related to the user query.

In some aspects, the information further comprises context related to the user query.

In some aspects, method 1000 further includes transmitting, to a third LM, the one or more content datasets and a third prompt (e.g., prompt 807) configured to cause the third LM to generate an enhanced response (e.g., enhanced response 818) to the user query using the one or more content datasets.

In some aspects, method 1000 further includes receiving, from the third LM, the enhanced response to the user query, the enhanced response comprising content selected from the one or more content datasets.

In some aspects, method 1000 further includes, in response to querying the content database, returning one or more suggestion chips (e.g., suggestion chips 312) selected from the content database that comprises suggestions for users to further prompt the third LM to retrieve additional information related to the user query.

In some aspects, method 1000 further includes causing the enhanced response to be presented at the user interface.

In some aspects, method 1000 further includes determining that the content dataset has been indexed, wherein transmitting, to the first LM, the content dataset and the first prompt as input occurs in response to identifying that the content dataset has been indexed.

In some aspects, method 1000 further includes identifying a set of metadata (e.g., metadata 442) corresponding to the content dataset (e.g., content dataset 420).

In some aspects, method 1000 further includes modifying the first prompt to cause the first LM to generate the set of synthetic queries related to the content dataset using the content dataset and the set of metadata corresponding to the content dataset.

In some aspects, method 1000 further includes transmitting, to the first LM, the set of metadata in combination with the content dataset and the modified first prompt.

In some aspects, the set of metadata comprises one or more of the following: product information, platform information, timestamp information, user preferences, or user feedback.

In some aspects, the first LM and the second LM are the same.

In some aspects, one or more of the first LM, the second LM, or third LM is a model provided by a third party.

In some aspects, generating the second output comprises: identifying the relevancy score threshold; and for each respective synthetic query in the set of synthetic queries: generating a relevancy score (e.g., relevancy score 608) for the respective synthetic query (e.g., synthetic query 612); determining whether the relevancy score for the respective synthetic query at least meets the relevancy score threshold; and in response to determining that the relevancy score at least meets the relevancy score threshold, retaining the respective synthetic query (e.g., synthetic query 612) corresponding to the relevancy score in the subset of synthetic queries.

In some aspects, generating the second output comprises, in response to determining that the relevancy score for the respective synthetic query does not meet the relevancy score threshold, discarding the respective synthetic query (e.g., discarded query 620) corresponding to the relevancy score.

In some aspects, identifying the relevancy score threshold comprises: accessing historical evaluation data; identifying a current quality score associated with a third LM; and determining a new value for the relevancy score threshold that will cause the third LM to achieve a new quality score that is higher than the current quality score.

In some aspects, generating the relevancy score comprises: for each respective synthetic query in the set of synthetic queries, receiving, from the second LM, a query response (e.g., synthetic query response 716) to the respective synthetic query (e.g., synthetic query 706), the query response comprising content selected from the content dataset (e.g., content dataset 714) corresponding to the set of synthetic queries (e.g., set of synthetic queries 704); parsing the query response into a plurality of parsed responses (e.g., parsed response 718, parse response 720, parsed response 722, etc.); determining whether each respective parsed response of the plurality of parsed responses matches at least one statement included in the content dataset; and determining the relevancy score (e.g., relevancy score 734) based on a number of statements that match at least one statement included in the content dataset in proportion to a total number of the plurality of statements.

In some aspects, method 1000 further includes performing a deduplication process on the subset of synthetic queries that prevents one or more duplicate synthetic queries from being indexed to a same content dataset.

In some aspects, method 1000 further includes receiving user feedback (e.g., user feedback 902) on an enhanced response presented to a user in response to a user query.

In some aspects, method 1000 further includes using the user feedback, the user query, and one or more synthetic queries related to the user query to update (e.g., using fine-tuning module 906) one or more parameters of the first LM, the second LM, or a third LM to cause the first LM, the second LM, or the third LM to provide outputs that are relevant to the user query.

In some aspects, method 1000 further includes updating an indexing of one or more content datasets with corresponding synthetic queries within the content database based on the user feedback.

By implementing RAG techniques with enhanced offline content in this manner, embodiments described herein improve upon the accuracy and reliability of RAG-enabled LM techniques and overcome technical problems associated with conventional RAG techniques. Embodiments described herein beneficially mitigate the technical problem of retrieving irrelevant content. For example, the indexing of the stored content is enhanced by indexing relevant synthetic queries with corresponding stored content. This enhances RAG by providing additional point of validation to ensure that the retrieved content is relevant to the user query because the vector embeddings of the user queries are now compared to both the vector queries of the stored content and the vector embeddings of the relevant synthetic queries. This allows the enhanced RAG to retrieve relevant content and avoid retrieving irrelevant content.

Note that FIG. 10 is just one example of a method, and other methods including fewer, additional, or alternative operations are possible consistent with this disclosure.

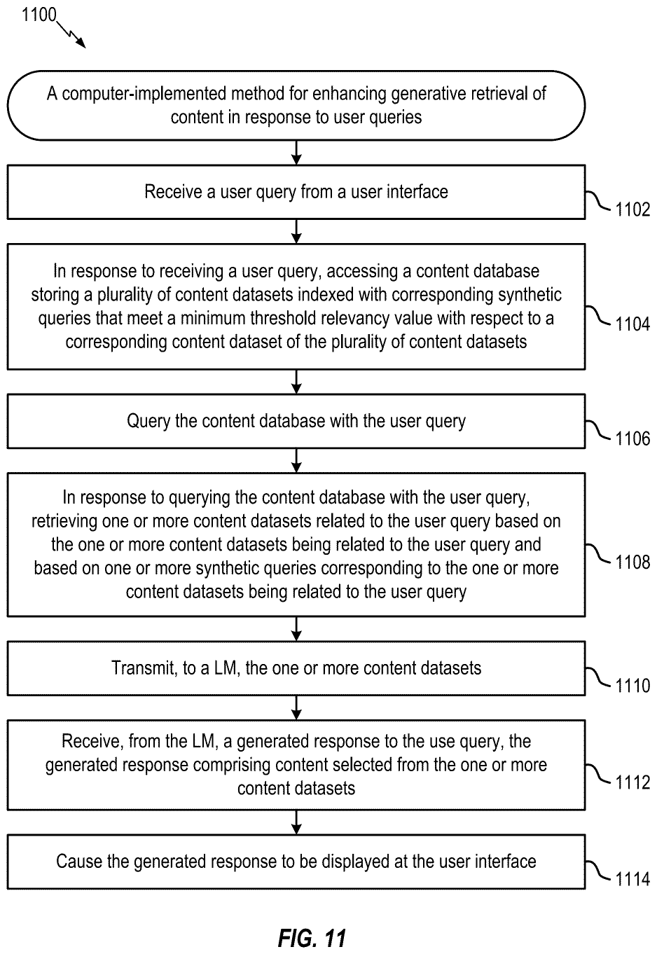

FIG. 11 depicts an example method 1100 for enhancing generative retrieval of content in response to user queries. In one aspect, method 1100 can be implemented by the processing system 1200 of FIG. 12.

Method 1100 starts at block 1102 with receiving a user query (e.g., user query 802) from a user interface (e.g., user interface 802).

Method 1100 continues to block 1104 with, in response to receiving a user query, accessing a content database (e.g., updated content database 808) storing a plurality of content datasets (e.g., content dataset 810, content dataset 814, etc.) indexed with corresponding synthetic queries (e.g., subset of synthetic queries 812 corresponding to content dataset 810, subset of synthetic queries 816 corresponding to content dataset 814) that meet a minimum threshold relevancy value with respect to a corresponding content dataset of the plurality of content datasets.

Method 1100 continues to block 1106 with querying the content database with the user query.

Method 1100 continues to block 1108 with, in response to querying the content database with the user query, retrieving one or more content datasets (e.g., content dataset 810) related to the user query based on the one or more content datasets being related to the user query and based on one or more synthetic queries corresponding to the one or more content datasets being related to the user query. Thus, aspects related to method 1100 can achieve reduced latency in generating responses to user queries because relevant content can be identified and retrieved more quickly and efficiently since the vector embeddings for the user query may be even more similar to (and therefore easier to identify as a match) to the vector embeddings of the relevant synthetic queries, than the vector embeddings of the corresponding content datasets. Notably, because the generating and indexing of synthetic queries with the stored content is performed offline, it doesn't impact the existing latency times associated with implementing RAG during real-time serving.

Method 1100 continues to block 1110 with transmitting, to a language model (LM) (e.g., user help generator 806), the one or more content datasets. Because the content retrieved by the method 1100 is validated as being relevant by comparing the user queries to both the content and the relevant synthetic queries, aspects of method 1100 are more likely to retrieve only relevant and similar content. This reduces the likelihood that irrelevant and relevant content is retrieved at the same time. Whereas any dissonance between the irrelevant and relevant content may have induced the LM to hallucinate, because the enhanced RAG is retrieving only relevant content, the LM is less likely to hallucinate during response generation because it will not get confused or need to reconcile differences between irrelevant and relevant content.

Method 1100 continues to block 1112 with receiving, from the LM, an enhanced response (e.g., enhanced response 818) to the user query, the enhanced response comprising content selected from the one or more content datasets. Accordingly, aspects of method 1100 beneficially improves the efficiency of retrieving the available content, as well as improves the relevancy of the content that is selected for retrieval. By improving the relevancy of retrieved content, the quality and accuracy of responses generated for user queries are improved.

Method 1100 continues to block 1114 with causing the enhanced response to be displayed at the user interface. Thus, method 1100 the overall user experience is also improved. Additionally, with improved response generation, systems also reduce the likelihood that users will escalate beyond the automated assistant, avoiding the need for expensive live agent interaction with the user.

Note that FIG. 11 is just one example of a method, and other methods including fewer, additional, or alternative operations are possible consistent with this disclosure.

### Example Processing System for Enhanced Generative Retrieval

FIG. 12 depicts an example processing system 1200 configured to perform various aspects described herein, including, for example, method 1000 as described above with respect to FIG. 10 and/or method 1100 as described above with respect to FIG. 11.

Processing system 1200 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 1200 includes one or more processors 1202, one or more input/output devices 1204, one or more display devices 1206, one or more network interfaces 1208 through which processing system 1200 is connected to one or more networks (e.g., a local network, an intranet, the Internet, or any other group of processing systems communicatively connected to each other), and computer-readable medium 1212. In the depicted example, the aforementioned components are coupled by a bus 1210, which may generally be configured for data exchange amongst the components. Bus 1210 may be representative of multiple buses, while only one is depicted for simplicity.

Processor(s) 1202 are generally configured to retrieve and execute instructions stored in one or more memories, including local memories like computer-readable medium 1212, as well as remote memories and data stores. Similarly, processor(s) 1202 are configured to store application data residing in local memories like the computer-readable medium 1212, as well as remote memories and data stores. More generally, bus 1210 is configured to transmit programming instructions and application data among the processor(s) 1202, display device(s) 1206, network interface(s) 1208, and/or computer-readable medium 1212. In certain embodiments, processor(s) 1202 are representative of a one or more central processing units (CPUs), graphics processing unit (GPUs), tensor processing unit (TPUs), accelerators, and other processing devices.

Input/output device(s) 1204 may include any device, mechanism, system, interactive display, and/or various other hardware and software components for communicating information between processing system 1200 and a user of processing system 1200. For example, input/output device(s) 1204 may include input hardware, such as a keyboard, touch screen, button, microphone, speaker, and/or other device for receiving inputs from the user and sending outputs to the user.

Display device(s) 1206 may generally include any sort of device configured to display data, information, graphics, user interface elements, and the like to a user. For example, display device(s) 1206 may include internal and external displays such as an internal display of a tablet computer or an external display for a server computer or a projector. Display device(s) 1206 may further include displays for devices, such as augmented, virtual, and/or extended reality devices. In various embodiments, display device(s) 1216 may be configured to display a graphical user interface.

Network interface(s) 1208 provide processing system 1200 with access to external networks and thereby to external processing systems. Network interface(s) 1208 can generally be any hardware and/or software capable of transmitting and/or receiving data via a wired or wireless network connection. Accordingly, network interface(s) 1208 can include a communication transceiver for sending and/or receiving any wired and/or wireless communication.

Computer-readable medium 1212 may be a volatile memory, such as a random access memory (RAM), or a nonvolatile memory, such as nonvolatile random access memory (NVRAM), or the like. In this example, computer-readable medium 1212 includes identifying component 1214, generating component 1216, transmitting component 1218, receiving component 1220, updating component 1222, querying component 1224, returning component 1226, causing component 1228, determining component 1230, modifying component 1232, retaining component 1234, discarding component 1236, accessing component 1238, performing component 1240, using component 1242, and retrieving component 1244. Processing of the components 1214-1244 may enable and cause the processing system 1200 to perform the method 1000 described with respect to FIG. 10, or any aspect related to it, and/or the method 1100 described with respect to FIG. 11, or any aspect related to it

In certain embodiments, identifying component 1214 is configured to identify a content dataset that is indexed in a content database that stores electronic content comprising information and context related to different user queries. In certain embodiments, generating component 1216 is configured to generate a first prompt configured to cause a first language model (LM) to generate a set of synthetic queries related to the content dataset. In certain embodiments, transmitting component 1218 is configured to transmit, to the first LM, the content dataset and the first prompt as a first input. In certain embodiments, receiving component 1220 is configured to receive, from the first LM, a first output comprising the set of synthetic queries related to the content dataset generated by the first LM based on the first input. In certain embodiments, generating component 1216 is configured to generate a second prompt configured to cause a second LM to determine a subset of the set of synthetic queries, the subset including one or more synthetic queries selected from the set of synthetic queries based on the one or more synthetic queries at least meeting a relevancy score threshold. In certain embodiments, transmitting component 1218 is configured to transmit, to the second LM, the set of synthetic queries and the second prompt as a second input. In certain embodiments, receiving component 1220 is configured to receive, from the second LM, a second output comprising the subset of synthetic queries generated by the second LM based on the second input. In certain embodiments, updating component 1222 is configured to update the content database by storing the subset of synthetic queries with the related content dataset.

In certain embodiments, receiving component 1220 is configured to receive a user query from a user interface. In certain embodiments, in response to receiving a user query, accessing component 1238 is configured to access a content database storing a plurality of content datasets indexed with corresponding synthetic queries that meet a minimum threshold relevancy value with respect to a corresponding content dataset of the plurality of content datasets. In certain embodiments, querying component 1224 is configured to query the content database with the user query. In certain embodiments, in response to querying the content database with the user query, retrieving component 1244 is configured to retrieve one or more content datasets related to the user query based on the one or more content datasets being related to the user query and based on one or more synthetic queries corresponding to the one or more content datasets being related to the user query. In certain embodiments, transmitting component 1218 is configured to transmit, to a language model (LM), the one or more content datasets. In certain embodiments, receiving component 1220 is configured to receive, from the LM, an enhanced response to the user query, the enhanced response comprising content selected from the one or more content datasets. In certain embodiments, causing component 1228 is configured to cause the enhanced response to be displayed at the user interface.

Note that FIG. 12 is just one example of a processing system consistent with aspects described herein, and other processing systems having additional, alternative, or fewer components are possible consistent with this disclosure.

### EXAMPLE CLAUSES

Implementation examples are described in the following numbered clauses:

Clause 1: A computer-implemented method for enhancing generative retrieval of content in response to user queries, comprising: identifying a content dataset that is indexed in a content database that stores electronic content comprising information and context related to different user queries; generating a first prompt configured to cause a first language model (LM) to generate a set of synthetic queries related to the content dataset; transmitting, to the first LM, the content dataset and the first prompt as a first input; receiving, from the first LM, a first output comprising the set of synthetic queries related to the content dataset generated by the first LM based on the first input; generating a second prompt configured to cause a second LM to determine a subset of the set of synthetic queries, the subset including one or more synthetic queries selected from the set of synthetic queries based on the one or more synthetic queries at least meeting a relevancy score threshold; transmitting, to the second LM, the set of synthetic queries and the second prompt as a second input; receiving, from the second LM, a second output comprising the subset of synthetic queries generated by the second LM based on the second input; and updating the content database by storing the subset of synthetic queries with the related content dataset.

Clause 2: The method of Clause 1, further comprising: receiving a user query from a user interface; in response to receiving the user query, identifying one or more related synthetic queries included in the subset of synthetic queries stored in the content database that are related to the user query; querying the content database using a combination of the user query and one or more related synthetic queries; and in response to querying the content database, returning one or more content datasets selected from the content database that provide information related to the user query.

Clause 3: The method of Clause 2, wherein the information further comprises context related to the user query.

Clause 4: The method of Clause 2, further comprising: transmitting, to a third LM, the one or more content datasets and a third prompt configured to cause the third LM to generate an enhanced response to the user query using the one or more content datasets; and receiving, from the third LM, the enhanced response to the user query, the enhanced response comprising content selected from the one or more content datasets.

Clause 5: The method of Clause 4, further comprising, in response to querying the content database, returning one or more suggestion chips selected from the content database that comprises suggestions for users to further prompt the third LM to retrieve additional information related to the user query.

Clause 6: The method of Clause 4, further comprising causing the enhanced response to be presented at the user interface.

Clause 7: The method of any one of Clauses 1-6, further comprising: determining that the content dataset has been indexed, wherein transmitting, to the first LM, the content dataset and the first prompt as input occurs in response to identifying that the content dataset has been indexed.

Clause 8: The method of any one of Clauses 1-7, further comprising: identifying a set of metadata corresponding to the content dataset; modifying the first prompt to cause the first LM to generate the set of synthetic queries related to the content dataset using the content dataset and the set of metadata corresponding to the content dataset; and transmitting, to the first LM, the set of metadata in combination with the content dataset and the modified first prompt.

Clause 9: The method of Clause 8, wherein the set of metadata comprises one or more of the following: product information, platform information, timestamp information, user preferences, or user feedback.

Clause 10: The method of any one of Clauses 1-9, wherein the first LM and the second LM are the same.

Clause 11: The method of any one of Clauses 1-10, wherein one or more of the first LM, the second LM, or third LM is a model provided by a third party.

Clause 12: The method of any one of Clauses 1-11, wherein generating the second output comprises: identifying the relevancy score threshold; and for each respective synthetic query in the set of synthetic queries: generating a relevancy score for the respective synthetic query; determining whether the relevancy score for the respective synthetic query at least meets the relevancy score threshold; and in response to determining that the relevancy score at least meets the relevancy score threshold, retaining the respective synthetic query corresponding to the relevancy score in the subset of synthetic queries.

Clause 13: The method of Clause 12, wherein generating the second output comprises, in response to determining that the relevancy score for the respective synthetic query does not meet the relevancy score threshold, discarding the respective synthetic query corresponding to the relevancy score.

Clause 14: The method of Clause 12, wherein identifying the relevancy score threshold comprises: accessing historical evaluation data; identifying a current quality score associated with a third LM; and determining a new value for the relevancy score threshold that will cause the third LM to achieve a new quality score that is higher than the current quality score.

Clause 15: The method of Clause 12, wherein generating the relevancy score comprises: for each respective synthetic query in the set of synthetic queries, receiving, from the second LM, a query response to the respective synthetic query, the query response comprising content selected from the content dataset corresponding to the set of synthetic queries; parsing the query response into a plurality of parsed responses; determining whether each respective parsed response of the plurality of parsed responses matches at least one statement included in the content dataset; and determining the relevancy score based on a number of statements that match at least one statement included in the content dataset in proportion to a total number of the plurality of statements.

Clause 16: The method of any one of Clauses 1-15, further comprising performing a deduplication process on the subset of synthetic queries that prevents one or more duplicate synthetic queries from being indexed to a same content dataset.

Clause 17: The method of any one of Clauses 1-16, further comprising: receiving user feedback on an enhanced response presented to a user in response to a user query; and using the user feedback, the user query, and one or more synthetic queries related to the user query to update one or more parameters of the first LM, the second LM, or a third LM to cause the first LM, the second LM, or the third LM to provide outputs that are relevant to the user query.

Clause 18: The method of Clause 17, further comprising updating an indexing of one or more content datasets with corresponding synthetic queries within the content database based on the user feedback.

Clause 19: A computer-implemented method for enhancing generative retrieval of content in response to user queries, comprising: receiving a user query from a user interface; in response to receiving a user query, accessing a content database storing a plurality of content datasets indexed with corresponding synthetic queries that meet a minimum threshold relevancy value with respect to a corresponding content dataset of the plurality of content datasets; querying the content database with the user query; in response to querying the content database with the user query, retrieving one or more content datasets related to the user query based on the one or more content datasets being related to the user query and based on one or more synthetic queries corresponding to the one or more content datasets being related to the user query; transmitting, to a language model (LM), the one or more content datasets; receiving, from the LM, an enhanced response to the user query, the enhanced response comprising content selected from the one or more content datasets; and causing the enhanced response to be displayed at the user interface.

Clause 20: A processing system, comprising: memory comprising computer-executable instructions; and one or more processors configured to execute the computer-executable instructions and cause the processing system to perform a method in accordance with any one of Clauses 1-19.

Clause 21: A processing system, comprising means for performing a method in accordance with any one of Clauses 1-19.

Clause 22: A non-transitory computer-readable medium storing program code for causing a processing system to perform the steps of any one of Clauses 1-19.

Clause 23: A computer program product embodied on a computer-readable storage medium comprising code for performing a method in accordance with any one of Clauses 1-19.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A computer-implemented method for enhancing generative retrieval of content in response to user queries, comprising:
identifying a content dataset that is indexed in a content database that stores electronic content comprising information and context related to different user queries,
wherein the different user queries are indexed with corresponding content datasets of the content database;
generating a first prompt configured to cause a first language model (LM) to generate a set of synthetic queries related to the content dataset;
transmitting, to the first LM, the content dataset and the first prompt as a first input;
receiving, from the first LM, a first output comprising the set of synthetic queries related to the content dataset generated by the first LM based on the first input;
generating a second prompt configured to cause a second LM to determine (1) a subset of the set of synthetic queries to be indexed with the content dataset in the content database, and (2) at least one synthetic query of the set of synthetic queries to be filtered from being indexed with the content dataset in the content database,
wherein the subset of the set of synthetic queries includes one or more synthetic queries selected from the set of synthetic queries based on the one or more synthetic queries at least meeting a relevancy score threshold, and excludes the at least one synthetic query based on the at least one synthetic query not meeting the relevancy score threshold;
transmitting, to the second LM, the set of synthetic queries and the second prompt as a second input;
receiving, from the second LM, a second output comprising the subset of the set of synthetic queries generated by the second LM based on the second input; and
updating the content database by storing the subset of the set of synthetic queries, wherein the subset of the set of synthetic queries is indexed with the content dataset.

2. The computer-implemented method of claim 1, further comprising:
receiving a user query from a user interface;
in response to receiving the user query, identifying one or more related synthetic queries included in the subset of the set of synthetic queries stored in the content database that are related to the user query;
querying the content database using a combination of the user query and the one or more related synthetic queries; and
based on querying the content database, obtaining one or more content datasets selected from the content database that provide information related to the user query.

3. The computer-implemented method of claim 2, wherein the information comprises context related to the user query.

4. The computer-implemented method of claim 2, further comprising:
transmitting, to a third LM, the one or more content datasets and a third prompt configured to cause the third LM to generate an enhanced response to the user query using the one or more content datasets; and
receiving, from the third LM, the enhanced response to the user query, the enhanced response comprising content selected from the one or more content datasets.

5. The computer-implemented method of claim 4, further comprising. in response to querying the content database, obtaining one or more suggestion chips, selected from the content database, that comprise suggestions for users to further prompt the third LM to retrieve additional information related to the user query.

6. The computer-implemented method of claim 4, further comprising causing the enhanced response to be presented at the user interface.

7. The computer-implemented method of claim 1, further comprising:
determining that the content dataset has been indexed,
wherein transmitting, to the first LM, the content dataset and the first prompt as the first input occurs in response to determining that the content dataset has been indexed.

8. The computer-implemented method of claim 1, further comprising:
identifying a set of metadata corresponding to the content dataset;
modifying the first prompt to cause the first LM to generate the set of synthetic queries related to the content dataset using the content dataset and the set of metadata corresponding to the content dataset; and
transmitting, to the first LM, the set of metadata in combination with the content dataset and the modified first prompt.

9. The computer-implemented method of claim 8, wherein the set of metadata comprises one or more of product information, platform information, timestamp information, user preferences, or user feedback.

10. The computer-implemented method of claim 1, wherein the first LM and the second LM are the same.

11. The computer-implemented method of claim 1, wherein each of one or more of the first LM or the second LM is a model provided by a third party.

12. The computer-implemented method of claim 1, wherein the second prompt comprises an instruction for the second LM to:
identify the relevancy score threshold; and
for a first synthetic query in the set of synthetic queries:
generate a first relevancy score for the first synthetic query;
determine whether the first relevancy score for the first synthetic query at least meets the relevancy score threshold; and
in response to determining that the first relevancy score at least meets the relevancy score threshold, retain the first synthetic query corresponding to the first relevancy score in the subset of the set of synthetic queries.

13. The computer-implemented method of claim 12, wherein the second prompt further comprises another instruction for the second LM to, in response to determining that a second relevancy score for a second synthetic query in the set of synthetic queries does not meet the relevancy score threshold, discard the second synthetic query corresponding to the second relevancy score.

14. The computer-implemented method of claim 12, wherein the second prompt further comprises another instruction for the second LM to:
access historical evaluation data;
identify a current quality score associated with a third LM; and
determine a new value for the relevancy score threshold that will cause the third LM to achieve a new quality score that is higher than the current quality score.

15. The computer-implemented method of claim 12, wherein the second prompt further comprises another instruction for the second LM to:
for each respective synthetic query in the set of synthetic queries,
generate a query response to the respective synthetic query, the query response comprising content selected from the content dataset corresponding to the set of synthetic queries;
parse the query response into a plurality of parsed responses;
determine whether each respective parsed response of the plurality of parsed responses matches at least one statement included in the content dataset; and
determine a relevancy score based on a number of parsed responses that match at least one statement included in the content dataset in proportion to a total number of parsed responses of the plurality of parsed responses.

16. The computer-implemented method of claim 1, further comprising performing a deduplication process on the subset of the set of synthetic queries that prevents one or more duplicate synthetic queries from being indexed to a same content dataset.

17. The computer-implemented method of claim 1, further comprising:
receiving user feedback on an enhanced response presented to a user in response to a user query; and
updating one or more parameters of the first LM, the second LM, or a third LM, by using the user feedback, the user query, and the one or more synthetic queries, to cause the first LM, the second LM, or the third LM to provide outputs that are relevant to the user query.

18. The computer-implemented method of claim 17, further comprising updating an indexing of one or more content datasets with corresponding synthetic queries within the content database based on the user feedback.

19. A processing system, comprising: one or more memories comprising computer-executable instructions; and one or more processors configured to execute the computer-executable instructions and cause the processing system to:
identify a content dataset that is indexed in a content database configured to store electronic content comprising information related to different user queries,
wherein the different user queries are indexed with corresponding content datasets of the content database;
generate a first prompt configured to cause a first language model (LM) to generate a set of synthetic queries related to the content dataset;
transmit, to the first LM, the content dataset and the first prompt as input;
receive, from the first LM, a first output comprising the set of synthetic queries related to the content dataset;
generate a second prompt configured to cause a second LM to determine (1) a subset of the set of synthetic queries to be indexed with the content dataset in the content database, and (2) at least one synthetic query of the set of synthetic queries to be filtered from being indexed with the content dataset in the content database,
wherein the subset of the set of synthetic queries includes one or more synthetic queries selected from the set of synthetic queries based on the one or more synthetic queries at least meeting a relevancy score threshold, and excludes the at least one synthetic query based on the at least one synthetic query not meeting the relevancy score threshold;
transmit, to the second LM, the set of synthetic queries and the second prompt as input;
receive, from the second LM, a second output comprising the subset of the set of synthetic queries; and
update the content database by storing the subset of the set of synthetic queries, wherein the subset of the set of synthetic queries is indexed with the content dataset.

20. A computer-implemented method for enhancing generative retrieval of content in response to user queries, comprising:
receiving a user query from a user interface;
in response to receiving the user query, accessing a content database storing a plurality of content datasets indexed with corresponding synthetic queries, wherein a respective synthetic query of the corresponding synthetic queries meets a relevancy score threshold with respect to a corresponding content dataset of the plurality of content datasets;
querying the content database with the user query;
in response to querying the content database with the user query, retrieving one or more content datasets related to the user query based on:
identifying the one or more content datasets as being related and responsive to the user query based on comparing a vector embedding of the user query against first vector embeddings of the plurality of content datasets and second vector embeddings of the corresponding synthetic queries indexed with the plurality of content datasets in the content database, and
identifying one or more synthetic queries as corresponding to the one or more content datasets being related to the user query;
transmitting, to a language model (LM), the one or more content datasets;
receiving, from the LM, an enhanced response to the user query, the enhanced response comprising content that is responsive to the user query and that is selected from the one or more content datasets; and
causing the enhanced response to be displayed at the user interface.
